(19) United States
(12) Patent Application Publication
(10) Pub. No.: US 2026/0217219 A1
(43) Pub. Date: Jul. 30, 2026

(54) VEHICLE CONTROL APPARATUS

(71) Applicant: TOYOTA JIDOSHA KABUSHIKI KAISHA, Toyota-shi (JP)

(72) Inventors: Ryosuke TANIMURA, Nagoya-shi (JP); Aika MIYAJIMA, Nagoya-shi (JP); Akari YAMADA, Nagoya-shi (JP); Reina YAMAMURA, Nagoya-shi (JP)

(73) Assignee: TOYOTA JIDOSHA KABUSHIKI KAISHA, Toyota-shi (JP)

(21) Appl. No.: 19/451,168

(22) Filed: Jan. 16, 2026

(30) Foreign Application Priority Data
Jan. 28, 2025 (JP) 2025-012432

(51) Int. Cl. B60R 25/20; B60H 1/00; B60R 25/01

(52) U.S. Cl. CPC B60R 25/2081; B60H 1/0065; B60R 25/01

(57) ABSTRACT

A vehicle control apparatus includes a processor. When the processor receives a first signal indicating that a payment of a debt for a vehicle is not properly made, the processor is configured to restrict one or some of functions included in the vehicle in response to receiving the first signal.

### CROSS-REFERENCE TO RELATED APPLICATION

This application claims priority to Japanese Patent Application No. 2025-012432 filed on January 28, 2025. The disclosure of the above-identified application, including the specification, drawings, and claims, is incorporated by reference herein in its entirety.

### BACKGROUND

### Technical Field

The present disclosure relates to a vehicle control apparatus.

### Description of Related Art

US 2023-0055958 A discloses a technique that notifies an in-vehicle computer of delinquency of a vehicle-related payment, transmits an acknowledgment request to acknowledge the delinquency notification, and then, when no acknowledgment response to the delinquency notification is received, disables the functions of components including an engine of a vehicle, an air conditioner, a radio, a global positioning system (GPS), and an MP3 player.

### SUMMARY

A creditor of a car lease or a car loan prefers that a payment be made rather than restricting the use of a vehicle and thus wants to induce a debtor to smoothly make a payment of money.

However, the technique disclosed in US 2023-0055958 A is insufficient to urge the debtor to make a payment on the debt because it only provides a notification regarding the status of loan payment or a delay in loan payment, or a payment reminder, and there is room for improvement.

The present disclosure provides a vehicle control apparatus that urges a debtor to make a payment on a debt.

A vehicle control apparatus according to a first aspect of the present disclosure is a vehicle control apparatus including a processor. When the processor receives, from a credit management server that manages a credit for a target vehicle, a first signal indicating that a payment of a debt for the target vehicle is not properly made, the processor executes control such that at least an ETC wireless device included in the target vehicle is disabled, in response to receiving the first signal.

A vehicle control apparatus according to a second aspect of the present disclosure is a vehicle control apparatus including a processor. The processor restricts one or some of functions included in a target vehicle when the processor receives a first signal indicating that a payment of a debt for the target vehicle is not properly made.

In the vehicle control apparatus according to the second aspect of the present disclosure, the restriction of the one or some of the functions may include executing control such that an electronic toll collection system (ETC) wireless device is disabled.

In the vehicle control apparatus according to the second aspect of the present disclosure, the restriction of the one or some of the functions may include executing control such that an air conditioner is disabled.

In the vehicle control apparatus according to the second aspect of the present disclosure, the execution of the control such that the air conditioner is disabled may include executing control such that at least one of heating, cooling, dehumidification, and ventilation of the air conditioner is disabled based on at least one of the current month, the current season, the current temperature, and the current humidity.

In the vehicle control apparatus according to the second aspect of the present disclosure, the restriction of the one or some of the functions may include executing control such that opening and closing of a plurality of doors included in the target vehicle other than a predetermined door is disabled.

In the vehicle control apparatus according to the second aspect of the present disclosure, the restriction of the one or some of the functions may include executing control such that a response level of at least one of a car navigation system, a voice assistant, and an artificial intelligence (AI) agent is made lower than a predetermined value.

In the vehicle control apparatus according to the second aspect of the present disclosure, the restriction of the one or some of the functions may include at least one of executing control such that setting of a predetermined area as a destination is disabled and executing control such that a guide to the predetermined area is disabled in a function of a car navigation system included in the target vehicle.

In the vehicle control apparatus according to the second aspect of the present disclosure, the processor may be configured to determine whether a second signal indicating that the debt has been fulfilled has been received. The processor may be configured to remove the restriction of the one or some of the functions when the processor determines that the second signal has been received.

In the vehicle control apparatus according to the second aspect of the present disclosure, the processor may be configured to execute remote control by outputting, to the target vehicle, a signal for restricting one or some of the functions included in the target vehicle through remote control, in response to receiving the first signal.

The present disclosure achieves the effect of urging the debtor to make a payment on the debt.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing the schematic configuration of a vehicle control system according to a first embodiment of the present disclosure;

FIG. 2 is a sequence diagram showing an example of exchange of information between a credit collection server, a credit management server, a vehicle information server, and a vehicle according to the first embodiment of the present disclosure;

FIG. 3 is a flowchart showing an overview of a process executed by the credit collection server according to the first embodiment of the present disclosure;

FIG. 4 is a flowchart showing an overview of a process executed by the vehicle information server according to the first embodiment of the present disclosure;

FIG. 5 is a flowchart showing an overview of a process executed by the vehicle according to the first embodiment of the present disclosure; and

FIG. 6 is a flowchart showing an overview of a process executed by a credit collection server according to a second embodiment of the present disclosure.

### DETAILED DESCRIPTION OF EMBODIMENTS

Hereinbelow, a vehicle control apparatus according to an embodiment of the present disclosure will be described with reference to the drawings. Note that components in the following embodiments include those that are easily replaceable by those skilled in the art, or substantially identical ones.

### First Embodiment

### Vehicle Control System

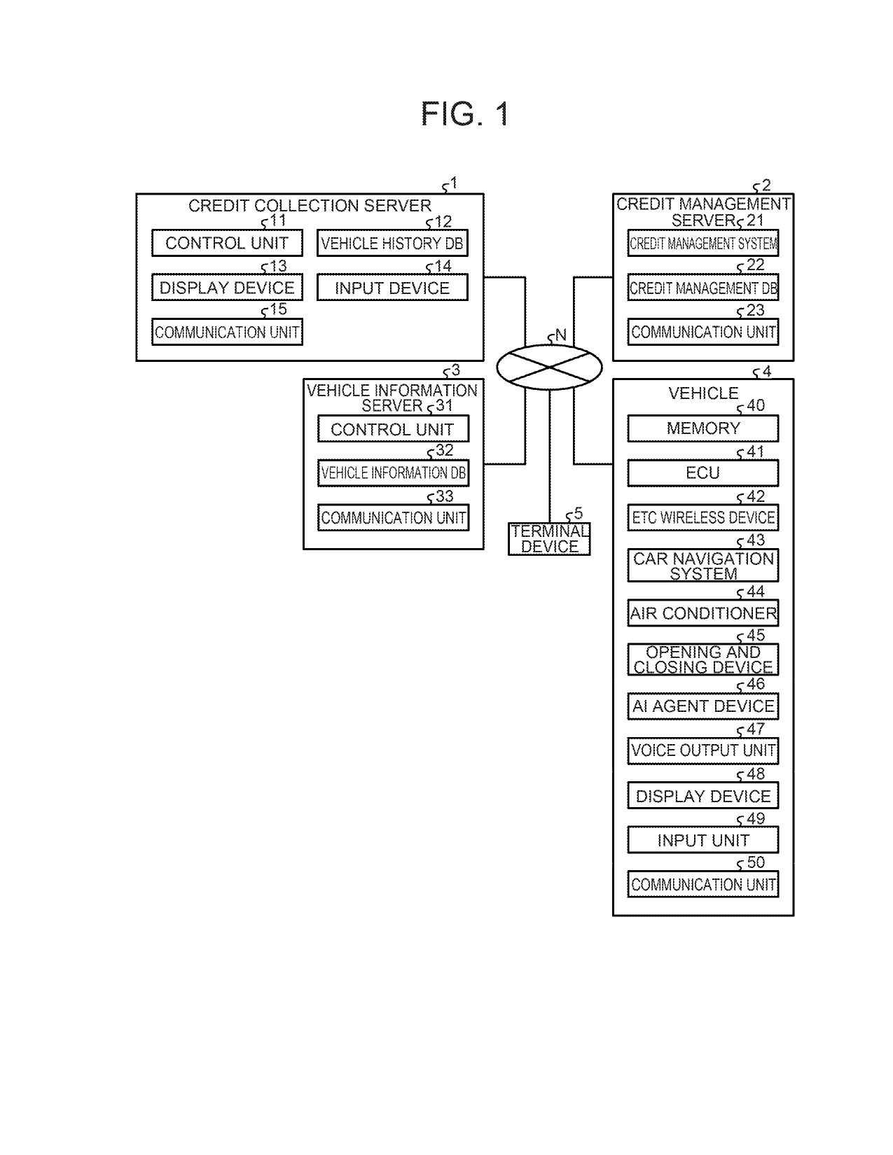

FIG. 1 is a block diagram showing the schematic configuration of a vehicle control system according to a first embodiment. A vehicle control system 100 shown in FIG. 1 includes a credit collection server 1, a credit management server 2, a vehicle information server 3, a vehicle 4, and a terminal device 5. The credit collection server 1, the credit management server 2, the vehicle information server 3, the vehicle 4, and the terminal device 5 all include communication functions and are configured to communicate with each other through a network N and exchange various kinds of information. The network N includes, for example, a public network such as an Internet network or a mobile phone network.

In the first embodiment, examples of the "credit" include a credit related to an installment agreement at vehicle purchase, a credit related to a lease agreement for a vehicle 4, a credit related to a subscription agreement for the vehicle 4, and a credit related to a rental car agreement for the vehicle 4.

A creditor in the first embodiment is, for example, the holder (owner) of the vehicle 4. Specifically, examples of the creditor include a dealer who sold the vehicle 4, a consumer credit company, and a bank. A debtor in the first embodiment is, for example, the user of the vehicle 4. Specifically, examples of the debtor include a purchaser of the vehicle 4, and an individual or a business company as a lessee under a lease agreement.

### Functional Configuration of Credit Collection Server

First, the functional configuration of the credit collection server 1 will be described. The credit collection server 1 remotely controls the operation of the vehicle 4 to collect the credit related to the vehicle 4. As shown in FIG. 1, the credit collection server 1 includes a control unit 11, a vehicle history database (DB) 12, a display device 13, an input device 14, and a communication unit 15.

The control unit 11 is implemented by, for example, a processor that includes a central processing unit (CPU), and a memory (main storage unit) that includes a random access memory (RAM) and a read only memory (ROM).

The vehicle history DB 12 is a database that includes a hard disk drive (HDD) or a solid state drive (SSD) and accumulates various kinds of information on the vehicle 4. The vehicle history DB 12 acquires, for example, usage status information from the vehicle information server 3 and accumulates the acquired usage status information in association with a vehicle identification number (VIN) or the like. In addition, the vehicle history DB 12 accumulates, for example, regular stop position information that is information on a position where the vehicle 4 is regularly or routinely stopped or parked, the regular stop position information being created based on positional information periodically transmitted from the vehicle 4.

The display device 13 is implemented by, for example, a liquid crystal display (LCD), or an organic EL display (OLED). The display device 13 displays various kinds of information under control of the control unit 11.

The input device 14 is implemented by, for example, a touch panel, a keyboard, or a pointing device. The input device 14 receives inputs of various operations from a user and outputs signals corresponding to the received operations to the control unit 11.

The communication unit 15 includes, for example, a local area network (LAN) interface board, and a wireless communication circuit for wireless communication. Under control of the control unit 11, the communication unit 15 exchanges information with the credit management server 2 and the vehicle information server 3, for example, by communication through the network N.

### Functional Configuration of Credit Management Server

Next, the functional configuration of the credit management server 2 will be described. The credit management server 2 is a server for managing the credit related to the vehicle 4. The credit management server 2 includes a credit management system 21, a credit management DB 22, and a communication unit 23.

When there is a vehicle 4 (target vehicle) that meets a requirement for restricting the function included in the vehicle among a plurality of vehicles 4 managed in the credit management DB 22, the credit management system 21 transmits information for identifying the vehicle 4 (target vehicle) (e.g., a vehicle identification number (VIN)) to the credit collection server 1. The vehicle 4 (target vehicle) that meets the requirement for function restriction includes the vehicle 4 (target vehicle) for which the debtor has delayed in payment or the like under the credit, the vehicle 4 (target vehicle) for which a payment of the debt is not properly made, and the vehicle 4 for which default or a delay in fulfilling the debt has occurred.

The credit management DB 22 manages information for identifying each vehicle 4 and information on the credit for the vehicle 4 in association with each other. The information for identifying each vehicle 4 is, for example, the vehicle identification number (VIN). The information on the credit for the vehicle 4 is, for example, repayment information indicating the payment status for a loan claim or a lease claim.

The communication unit 23 includes, for example, a LAN interface board, and a wireless communication circuit for wireless communication. The communication unit 23 exchanges information with the credit collection server 1, for example, by communication through the network N.

### Functional Configuration of Vehicle Information Server

Next, the functional configuration of the vehicle information server 3 will be described. The vehicle information server 3 acquires usage status information from the vehicle 4 in accordance with a request from the credit collection server 1, and transmits the acquired usage status information to the credit collection server 1. The vehicle information server 3 includes a control unit 31, a vehicle information DB 32, and a communication unit 33.

The control unit 31 is implemented by, for example, a processor that includes a CPU, and a memory (main storage unit) that includes a RAM and a ROM. The control unit 31 acquires usage status information from the vehicle 4 in accordance with a request from the credit collection server 1, and transmits the acquired usage status information to the credit collection server 1.

The vehicle information DB 32 accumulates the usage status information acquired from the vehicle 4 (the target vehicle) and information for identifying the vehicle 4 (e.g., the vehicle identification number (VIN)) in association with each other. Under control of the control unit 31, the vehicle information DB 32 transmits the usage status information to the credit collection server 1 in accordance with a request from the credit collection server 1.

The communication unit 33 includes, for example, a LAN interface board, and a wireless communication circuit for wireless communication. The communication unit 33 exchanges information with the credit collection server 1, the credit management server 2, and the vehicle 4, for example, by communication through the network N.

### Functional Configuration of Vehicle

Next, the functional configuration of the vehicle 4 will be described. The vehicle 4 is, for example, a conventional vehicle (CONV), a hybrid electric vehicle (HEV), or a plug-in hybrid electric vehicle (PHEV). The vehicle 4 may be, for example, a fuel cell electric vehicle (FCEV) or a battery electric vehicle (BEV).

The vehicle 4 includes a memory 40, an ECU 41, an electronic toll collection system (ETC) wireless device 42, a car navigation system 43, an air conditioner 44, an opening and closing device 45, an artificial intelligence (AI) agent device 46, a display device 48, a voice output unit 47, an input unit 49, and a communication unit 50.

The memory 40 records various kinds of information on the vehicle 4, programs to be executed by the ECU 41, and two-dimensional (2D) map information or three-dimensional (3D) map information to be used by the car navigation system 43. In addition, the memory 40 includes an HDD, an SSD, or the like.

The ECU41 is an electronic control unit that includes, as a primary component, a microcomputer including, for example, a CPU, a ROM, and a RAM. When the vehicle 4 meets a predetermined requirement for restricting one or some of the functions included in the vehicle 4 (hereinbelow, referred to as the "function lock requirement"), the ECU 41 receives predetermined information from the vehicle information server 3, and restricts the one or some of the functions included in the vehicle 4 based on the information. The "function lock requirement" is, for example, a case in which the debtor of the vehicle 4 is in default on the debt (such as a payment delay). Determination of whether the function lock requirement is met is performed, for example, by the credit management server 2. When there is a vehicle 4 (target vehicle) that meets the function lock requirement, information for identifying the vehicle 4 (target vehicle) (e.g., the vehicle identification number (VIN)) is transmitted from the credit management server 2 to the vehicle 4 through the credit collection server 1 and the vehicle information server 3. The target vehicle refers to, for example, the vehicle 4 subject to the credit.

In addition, when the ECU 41 receives a second signal indicating, for example, that the debt for the vehicle 4 with the function lock has been fulfilled, the ECU 41 removes the function restriction on the vehicle 4.

In addition, when the ECU 41 receives, from the vehicle information server 3, a first signal indicating that a payment of the debt for the vehicle 4 (the target vehicle) is not properly made (hereinbelow, simply referred to as the "first signal"), the ECU 41 restricts one or some of the functions included in the vehicle 4. Furthermore, the ECU 41 maintains the function restriction on the vehicle 4 until the ECU 41 receives, from the vehicle information server 3, the second signal indicating that the debt for the vehicle 4 (target vehicle) has been fulfilled (hereinbelow, simply referred to as the "second signal"). Note that, in the first embodiment, the ECU 41 functions as the processor of the vehicle control apparatus.

The ETC wireless device 42 includes an antenna-integrated in-vehicle device into which an ETC card can be inserted. The ETC wireless device 42 wirelessly communicates with a roadside antenna in an ETC lane under control of the ECU 41.

The car navigation system 43 receives, for example, radio waves from a global positioning system (GPS) satellite, detects the current position of the vehicle 4, searches for a route corresponding to a destination input by the user, and displays the route on the display device 48. The method of detecting the current position of the vehicle 4 is not limited to the method using the GPS satellite. For example, a method that combines light detection and ranging or laser imaging detection and ranging (LiDAR) with two-dimensional or three-dimensional map information recorded in the memory 40 may be used.

The air conditioner 44 includes a compressor, a condenser, a receiver, a cooling unit, and the like. Under control of the ECU 41, the air conditioner 44 supplies warm air, cool air, or ventilation air into a vehicle cabin of the vehicle 4 at a predetermined airflow rate.

The opening and closing device 45 includes a motor, a cable member, a door position detection sensor, and the like, and opens and closes, and locks and unlocks an automatic door provided on the vehicle 4 under control of the ECU 41.

The AI agent device 46 includes hardware such as a microcomputer including a memory, a CPU, a ROM, a RAM, and the like, a microphone, and a speaker, and large language models (LLM) including a large dataset and deep learning. Under control of the ECU 41, the AI agent device 46 receives an input of voice (voice data) uttered by a speaker, and outputs, as voice, a reply corresponding to the received voice, or changes the function included in the vehicle 4, for example, sets the destination in the car navigation system 43 or adjusts the temperature and airflow rate of air conditioning performed by the air conditioner 44.

The display device 48 is implemented by, for example, a liquid crystal display (LCD) or an organic EL display (OLED), is provided inside the vehicle cabin of the vehicle 4, and functions as an in-vehicle display. The display device 48 displays various kinds of information under control of the ECU 41.

The voice output unit 47 includes a speaker, a DA conversion circuit, an amplifier, and the like. The voice output unit 47 outputs various kinds of information under control of the ECU 41. For example, the voice output unit 47 converts digital voice data input thereto from the ECU 41 into analog voice data, and outputs the analog voice data to outside.

The input unit 49 is implemented by, for example, a touch panel, a keyboard, or a pointing device. The input unit 49 receives inputs of various operations from a user and outputs signals corresponding to the received operations to the ECU 41.

The communication unit 50 includes, for example, a data communication module (DCM). The communication unit 50 exchanges information with the vehicle information server 3, for example, by communication through the network N.

### Terminal Device

Next, the terminal device 5 will be described. The terminal device 5 is an information processing terminal, such as a mobile phone. The terminal device 5 receives inputs of various operations from the debtor. In addition, when one or some of the functions of the vehicle 4 are restricted, the terminal device 5 displays a message transmitted from the vehicle 4, the message indicating that the one or some of the functions of the vehicle 4 are restricted.

### Exchange of Information between Devices of Vehicle Control System

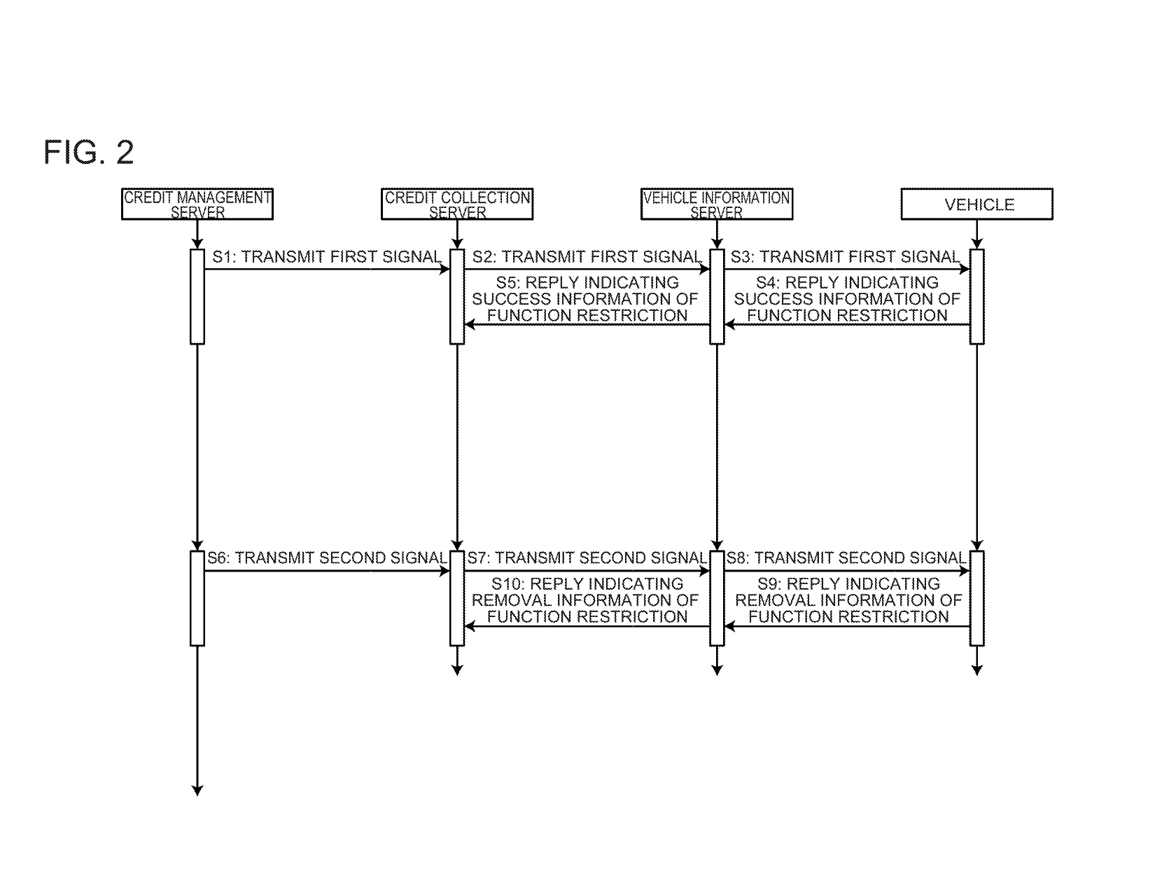

Next, exchange of information between the credit collection server 1, the credit management server 2, the vehicle information server 3, and the vehicle 4 will be described. FIG. 2 is a sequence diagram showing an example of the exchange of information between the credit collection server 1, the credit management server 2, the vehicle information server 3, and the vehicle 4. Note that in the following process, a process executed on, among the vehicles 4, the vehicle 4 (target vehicle) that is used by the debtor who has delayed in payment on the debt will be described as an example.

As shown in FIG. 2, first, the credit management server 2 transmits, to the credit collection server 1, the first signal indicating, for example, that a payment of the debt is not properly made (step S1). Then, the control unit 11 of the credit collection server 1 transmits the first signal received from the credit management server 2 to the vehicle information server 3 (step S2). Then, the vehicle information server 3 transmits the first signal received from the credit collection server 1 to the vehicle 4 (step S3). In response to this, the ECU 41 of the vehicle 4 restricts one or some of the functions of the vehicle 4 and makes a reply indicating success information of the function restriction on the vehicle 4 to the vehicle information server 3 (step S4). In this case, the ECU 41 of the vehicle 4, for example, restricts any one or more of the functions of the ETC wireless device 42, the car navigation system 43, the air conditioner 44, the opening and closing device 45, and the AI agent device 46. Details of the function restriction executed by the ECU 41 will be described further below. Then, the vehicle information server 3 transmits, to the credit collection server 1, the reply indicating the success information of the function restriction received from vehicle 4 (step S5). In this case, the credit collection server 1 accumulates, in the vehicle history DB 12, the success information of the function restriction on the vehicle 4 received from the vehicle information server 3 and the vehicle identification number (VIN) of the vehicle 4 in association with each other.

Next, the credit management server 2 transmits, to the credit collection server 1, the second signal indicating, for example, that the debt for the vehicle 4 has been fulfilled (step S6). Then, the control unit 11 of the credit collection server 1 transmits the second signal received from the credit management server 2 to the vehicle information server 3 (step S7). Then, the vehicle information server 3 transmits the second signal received from the credit collection server 1 to the vehicle 4 (step S8). In response to this, the ECU 41 of the vehicle 4 removes the restriction of the one or some of the functions of the vehicle 4 and makes a reply indicating removal information of the function restriction to the vehicle information server 3 (step S9). In this case, the ECU 41, for example, removes the restriction of any one or more of the functions of the ETC wireless device 42, the car navigation system 43, the air conditioner 44, the opening and closing device 45, and the AI agent device 46. This enables the debtor to use the vehicle 4 without function restriction on the vehicle 4, in this case. Then, the vehicle information server 3 transmits, to the credit collection server 1, the reply indicating the removal information received from the vehicle 4 (step S10). In this case, the credit collection server 1 accumulates, in the vehicle history DB 12, the removal information received from the vehicle information server 3 and the vehicle identification number (VIN) of the vehicle 4 in association with each other.

### Process in Credit Collection Server

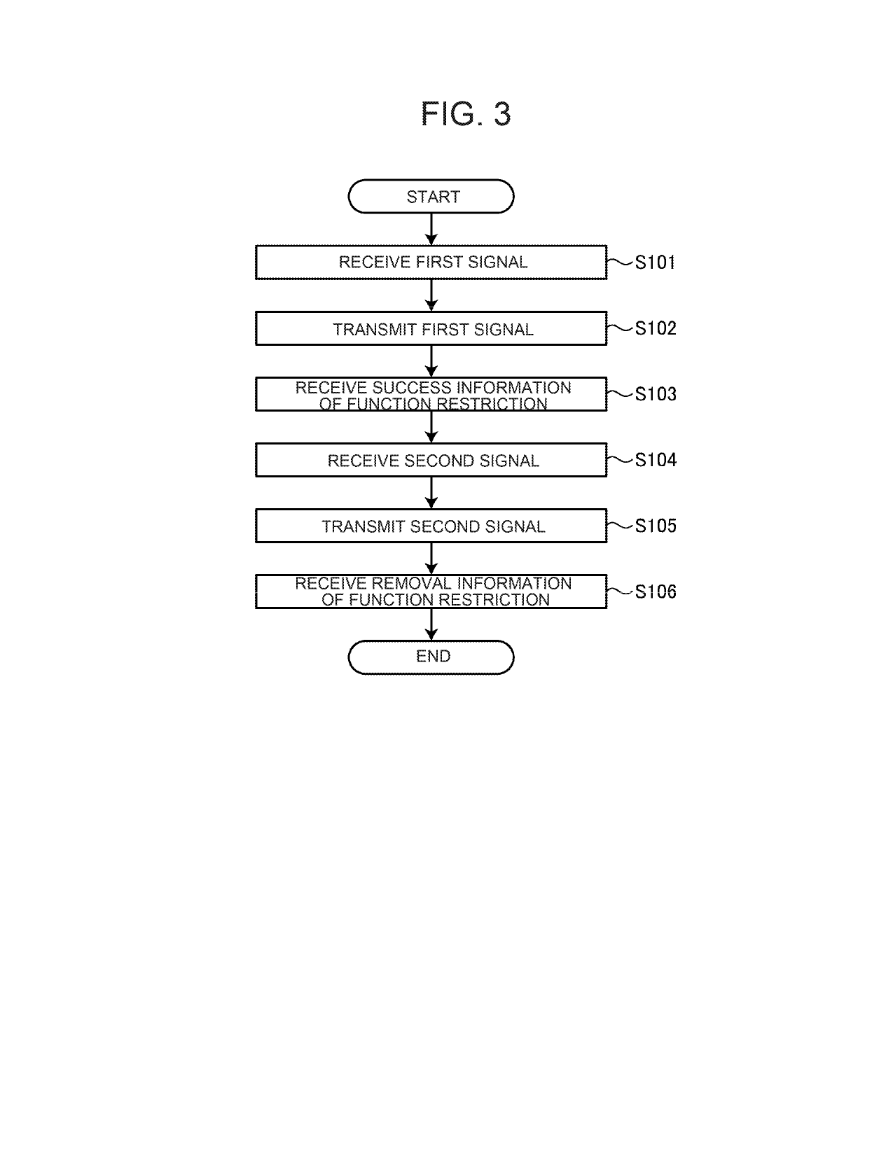

Next, a process executed by the credit collection server 1 will be described. FIG. 3 is a flowchart showing an overview of the process executed by the credit collection server 1.

As shown in FIG. 3, when the control unit 11 receives, from the credit management server 2, the first signal indicating, for example, that a payment of the debt is not properly made (step S101), the control unit 11 transmits the first signal from the credit management server 2 to the vehicle information server 3 (step S102). Then, the control unit 11 receives the success information of the function restriction on the vehicle 4 from the vehicle information server 3 (step S103).

Then, when the control unit 11 receives, from the credit management server 2, the second signal indicating, for example, that the debt for the vehicle 4 has been fulfilled (step S104), the control unit 11 transmits the second signal to the vehicle information server 3 (step S105). Then, the control unit 11 receives the removal information of the function restriction from the vehicle information server 3 (step S106). After step S106, the credit collection server 1 finishes the process.

### Process in Vehicle Information Server

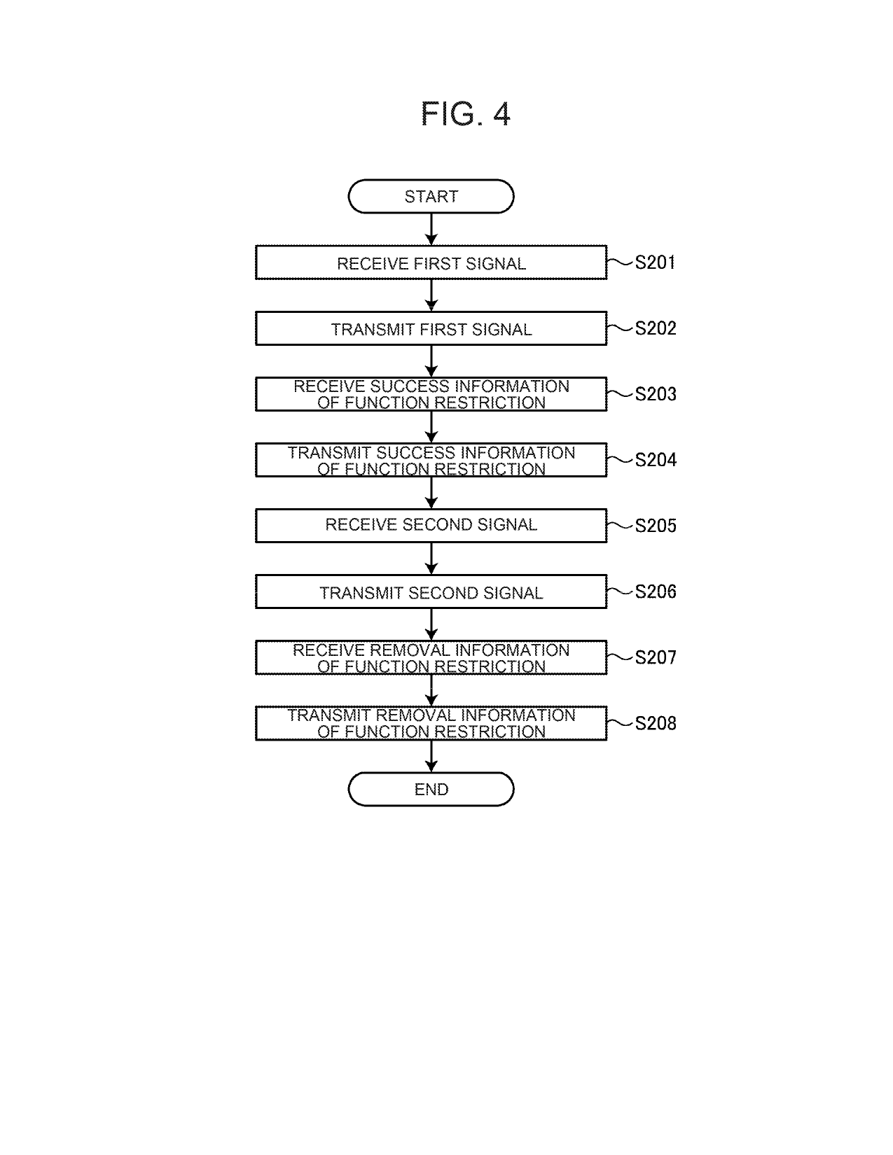

Next, an overview of a process executed by the vehicle information server 3 will be described. FIG. 4 is a flowchart showing the overview of the process executed by the vehicle information server 3.

As shown in FIG. 4, first, the control unit 31 receives, from the credit collection server 1, the first signal indicating, for example, that a payment of the debt is not properly made (step S201), and transmits the received first signal to the vehicle 4 (step S202).

Then, the control unit 31 receives the success information of the function restriction on the vehicle 4 from the vehicle 4 (step S203), and transmits the received success information of the function restriction on the vehicle 4 to the credit collection server 1 (step S204).

Then, the control unit 31 receives, from the credit collection server 1, the second signal indicating, for example, that the debt for the vehicle 4 has been fulfilled (step S205), and transmits the received second signal to the vehicle 4 (step S206).

Then, the control unit 31 receives the removal information of the function restriction from the vehicle 4 (step S207), and transmits the received removal information to the credit collection server 1 (step S208). After step S208, the vehicle information server 3 finishes the process.

### Process in Vehicle

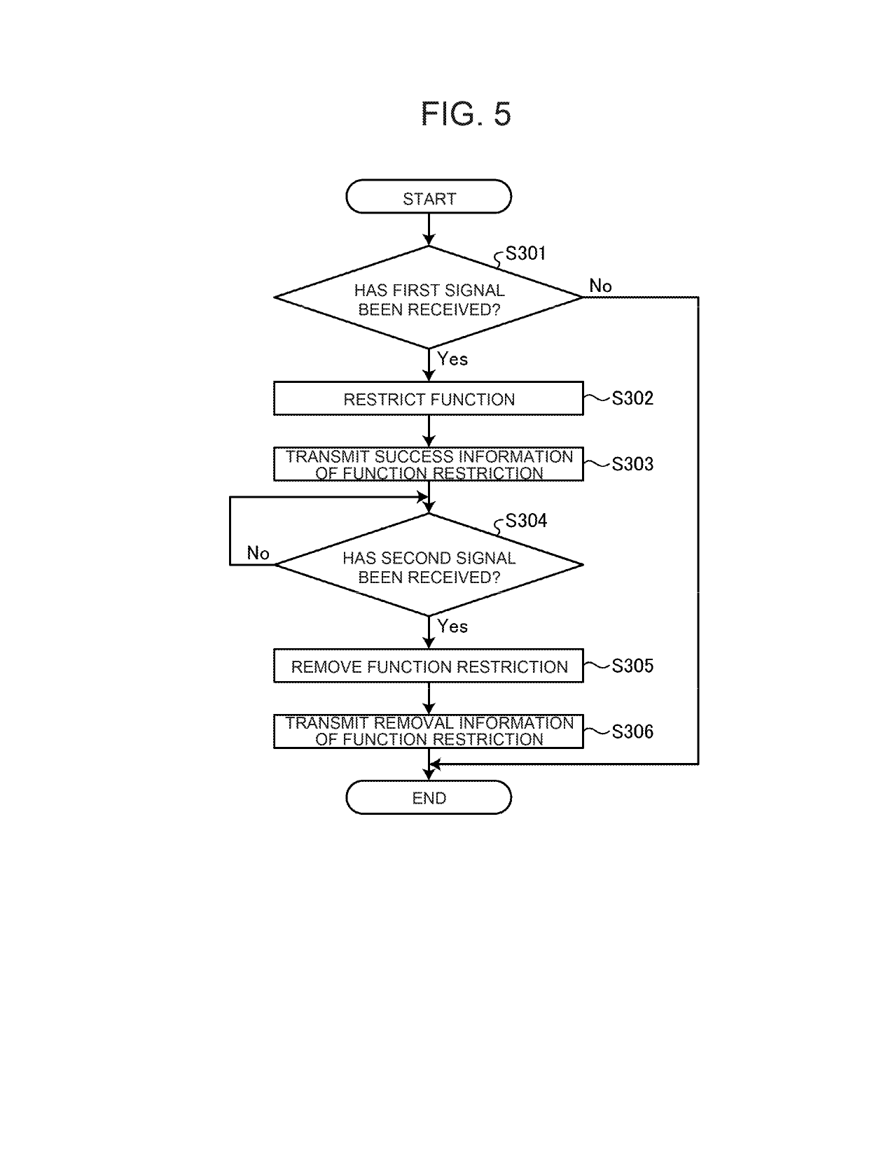

Next, an overview of a process executed by the vehicle 4 will be described. FIG. 5 is a flowchart showing the overview of the process executed by the vehicle 4.

As shown in FIG. 5, first, when the ECU 41 receives, from the vehicle information server 3, the first signal indicating, for example, that a payment of the debt is not properly made (step S301: Yes), the ECU 41 restricts one or some of the functions included in the vehicle 4 (step S302). Specifically, the ECU 41 restricts, for example, at least one of the functions (1) to (6) below.

(1) The ECU 41 executes control such that the ETC wireless device 42 is disabled. Specifically, the ECU 41 turns off the power of the ETC wireless device 42 or stops its wireless communication function. In this case, the ECU 41 displays, on the display device 48, a message indicating that it is not possible to pass through a tollgate on a toll road using the ETC wireless device 42, or causes the voice output unit 47 to emit voice stating that the function of the ETC wireless device 42 is restricted. This enables the user to understand that it is not possible to pass through the tollgate on the toll road using the ETC wireless device 42.

(2) The ECU 41 executes control such that the air conditioner 44 is disabled. For example, even when the user operates the input unit 49 to perform an operation to specify any of the temperature, the humidity, and the airflow rate of the air conditioner 44, the ECU 41 does not accept the operation. In this case, the ECU 41 displays, on the display device 48, a message indicating that the air conditioner 44 is disabled, or causes the voice output unit 47 to emit voice stating that the air conditioner 44 is disabled. This enables the user to understand that the function of the air conditioner 44 is restricted.

(3) When the ECU 41 executes the control such that the air conditioner 44 is disabled, the ECU 41 may execute control such that at least one of heating, cooling, dehumidification, and ventilation of the air conditioner 44 is disabled based on at least one of the current month, the current season, the current temperature, and the current humidity. For example, the ECU 41 executes control such that cooling of the air conditioner 44 is disabled during summer. Specifically, even when the user operates the input unit 49 to lower the temperature of the air conditioner 44, the ECU 41 does not drive the compressor of the air conditioner 44. Of course, for example, the ECU 41 may control the air conditioner 44 such that warm air is not supplied from the air conditioner 44 during winter. Note that the ECU 41 may restrict one or some of the functions of the air conditioner 44 based on the time of day, place, season, or the like when or where the vehicle 4 is used. For example, when the vehicle 4 is located in a cold climate area, even when the ECU 41 receives the first signal indicating that a payment of the debt is not properly made, the ECU 41 may enable the air conditioner 44 to be used up to a temperature that does not threaten life. This makes it possible to urge the debtor to make a payment on the debt while ensuring the safety of the debtor.

(4) The ECU 41 controls the opening and closing device 45 such that opening and closing of a plurality of doors included in the vehicle 4 other than a predetermined door is disabled. Specifically, the ECU 41 may control the opening and closing device 45 such that opening and closing of the doors other than the driver-side door is disabled, or such that opening and closing of only the left-side door or the passenger-side door of the vehicle 4 is enabled. In this case, for example, the ECU 41 may transmit, to the display device 48 or the terminal device 5, a message indicating that the openable door in the vehicle 4 is only the driver-side door. Note that, since the position of a steering wheel of the vehicle 4 varies from country to country, the ECU 41 may execute control such that opening and closing of the doors other than the predetermined door is disabled in accordance with the position of the steering wheel (driver's seat) of the vehicle 4.

(5) The ECU 41 executes control such that the content of a response level of the AI agent device 46 is made lower than a predetermined value. Specifically, the ECU 41 restricts the response level of voice output by the AI agent device 46 by switching conditions previously defined in the AI agent device 46 and behavior rules set for each level for the voice received by the input unit 49. For example, the ECU 41 restricts the response level of the AI agent device 46 to be lower than the predetermined value by responding to the input content input by the user through the input unit 49 with contents ranging from polite to rude conversation levels, reducing the search accuracy for the input content, or reducing the response speed. More specifically, the AI agent device 46 responds to the input content input by the user through the input unit 49 with replies ranging from a polite conversation level like "certainly" to a rude conversation level like "yeah". Note that although the first embodiment assumes the response level of the AI agent device 46, this is not a limitation. For example, the response level may be the response level of the car navigation system 43, a voice assistant, or a car multimedia.

(6) The ECU 41 executes control such that setting of a predetermined area as a destination is disabled or executes control such that a guide to the predetermined area is disabled in the function of the car navigation system 43 included in the vehicle 4. Specifically, when the user operates the car navigation system 43 through the input unit 49, the ECU 41 restricts the function of the car navigation system 43, for example, by performing restriction such that the user's desired destination is not displayed in a search result of the car navigation system 43, displaying a route that bypasses an area of the destination on the display device 48, or finishing the guide before the destination. Note that the ECU 41 may restrict the car navigation system 43 such that even when the destination that has been input by the user to the car navigation system 43 through the input unit 49 and searched is displayed on the display device 48, the user cannot select the destination.

In this manner, the ECU 41 restricts, for example, at least one of the functions of (1) to (6) described above. This makes it possible to urge the debtor to make a payment on the debt.

Then, when the function restriction on the vehicle 4 is successfully completed, the ECU 41 transmits the success information of the function restriction on the vehicle 4 to the vehicle information server 3 (step S303).

Then, the ECU 41 determines whether the second signal indicating, for example, that the debt for the vehicle 4 has been fulfilled has been received from the vehicle information server 3 (step S304). When the ECU 41 determines that the second signal has been received from the vehicle information server 3 (step S304: Yes), the vehicle 4 shifts to step S305. On the other hand, when the ECU 41 determines that the second signal has not been received from the vehicle information server 3 (step S304: No), the vehicle 4 repeats the determination in step S304.

Then, the ECU 41 removes the function restriction executed in step S302 (step S305), and transmits the removal information of the function restriction to the vehicle information server 3 (step S306). After step S306, the vehicle 4 finishes the process.

With the first embodiment described above, since the ECU 41 restricts one or some of the functions of the vehicle 4 when the ECU 41 receives the first signal, it is possible to urge the debtor to make a payment on the debt.

In addition, with the first embodiment, the ECU 41 executes control such that the ETC wireless device 42 is disabled to prevent the debtor from passing through a tollgate on a toll road using the ETC wireless device 42, thereby making it possible to urge the debtor to make a payment on the debt.

In addition, with the first embodiment, since the ECU 41 executes control such that the air conditioner 44 is disabled, and the debtor cannot perform air conditioning of the vehicle 4 using the air conditioner 44, it is possible to urge the debtor to make a payment on the debt.

In addition, with the first embodiment, since the ECU 41 executes control such that at least one of heating, cooling, dehumidification, and ventilation of the air conditioner 44 is disabled based on at least one of the current month, the current season, the current temperature, and the current humidity, and the debtor cannot perform desired air conditioning in the vehicle 4 using the air conditioner 44, it is possible to urge the debtor to make a payment on the debt.

In addition, with the first embodiment, since the ECU 41 controls the opening and closing device 45 such that opening and closing of the doors included in the vehicle 4 other than the predetermined door is disabled, and a person other than the debtor or the user cannot open and close the desired door, it is possible to urge the debtor to make a payment on the debt.

In addition, with the first embodiment, since the ECU 41 executes control such that the content of at least one response level of the AI agent device 46 is made lower than the predetermined value, and the AI agent device 46 responds to the debtor in an unpleasant manner, it is possible to urge the debtor to make a payment on the debt.

In addition, with the first embodiment, since the ECU 41 executes control such that setting of a predetermined area as a destination is disabled or executes control such that a guide to the predetermined area is disabled in the function of the car navigation system 43 included in the vehicle 4, it becomes difficult for the debtor to reach the desired destination, and it is possible to urge the debtor to make a payment on the debt.

### Second Embodiment

Next, a second embodiment will be described. In the first embodiment, when the ECU 41 of the vehicle 4 receives the first signal, the ECU 41 restricts one or some of the functions included in the vehicle 4. However, in the second embodiment, the control unit 11 of the credit collection server 1 executes the same process through remote control. That is, in the second embodiment, the control unit 11 functions as the vehicle control apparatus. Hereinbelow, the process executed by the credit collection server 1 according to the second embodiment will be described.

### Process in Credit Collection Server

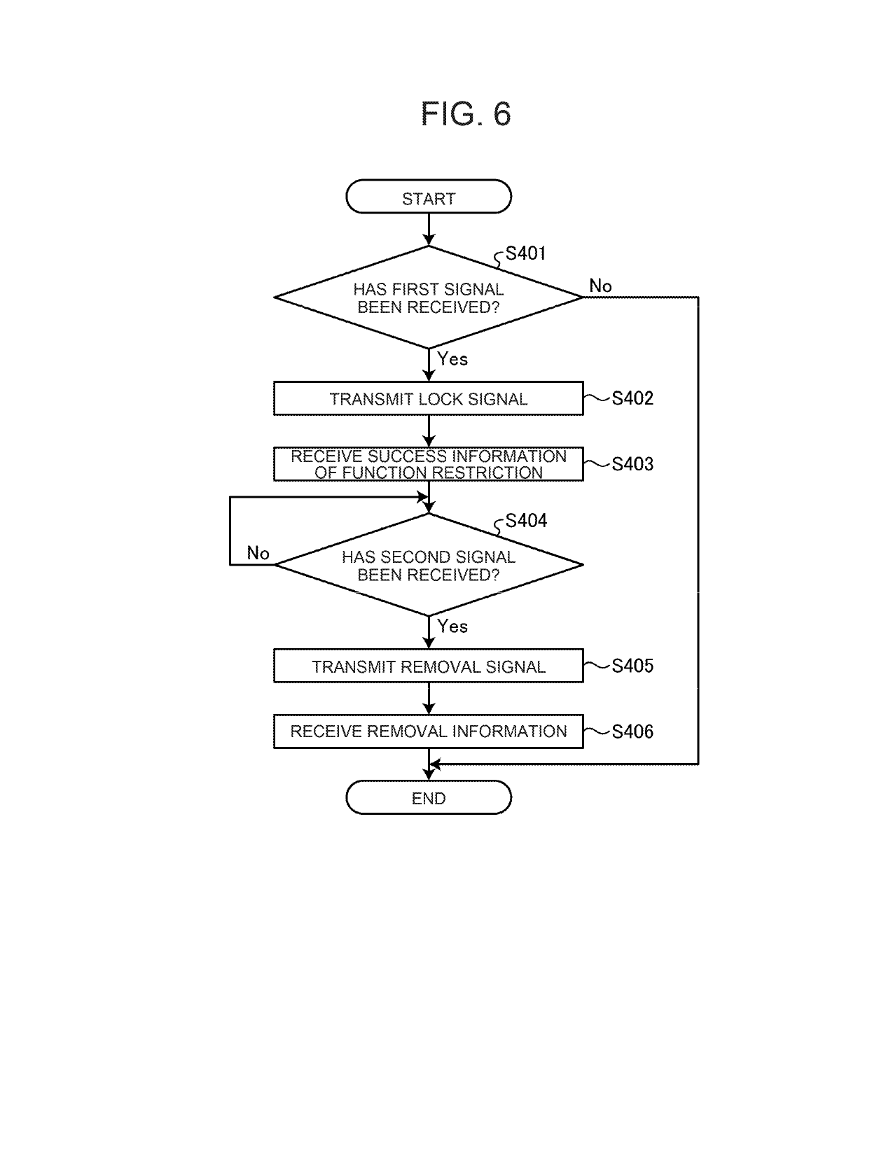

FIG. 6 is a flowchart showing an overview of the process executed by the credit collection server 1 according to the second embodiment. Note that, in the second embodiment, the control unit 11 of the credit collection server 1 functions as the processor of the vehicle control apparatus.

As shown in FIG. 6, when the control unit 11 receives, from the credit management server 2, a first signal indicating, for example, that a payment of the debt is not properly made (step S401: Yes), the control unit 11 transmits a signal for restricting one or some of the functions of the vehicle 4 through remote control (hereinbelow, simply referred to as the "lock signal") to the vehicle 4 through the vehicle information server 3 (step S402). In this case, the ECU 41 of the vehicle 4 restricts the one or some of the functions included in the vehicle 4 in accordance with the lock signal through remote control from the credit collection server 1. Specifically, the ECU 41 of the vehicle 4 restricts, for example, at least one of the functions of (1) to (6) described above in the first embodiment, in accordance with the lock signal through remote control from the credit collection server 1.

Then, the control unit 11 receives success information of the function restriction on the vehicle 4 from the vehicle 4 through the vehicle information server 3 (step S403).

Then, the control unit 11 determines whether a second signal indicating, for example, that the debt for the vehicle 4 has been fulfilled has been received from the credit management server 2 (step S404). When the control unit 11 determines that the second signal has been received from the credit management server 2 (step S404: Yes), the credit collection server 1 shifts to step S405. On the other hand, when the control unit 11 determines that the second signal has not been received from the credit management server 2 (step S404: No), the control unit 11 repeats the determination in step S404.

Then, the control unit 11 transmits, to the vehicle 4 through the vehicle information server 3, a removal signal for removing the function restriction on the vehicle 4 through remote control (step S405). In this case, the ECU 41 of the vehicle 4 removes the restriction of the function included in the vehicle 4 in accordance with the removal signal through remote control from the credit collection server 1. In this case, the control unit 11 may display, on the display device 48 of the vehicle 4, a message indicating that the function restriction on the vehicle 4 has been removed through the vehicle information server 3, or may transmit the message to the terminal device 5 and display the message on the terminal device 5.

Then, the control unit 11 receives removal information of the function restriction from the vehicle 4 through the credit management server 2 (step S406). After step S406, the credit collection server 1 finishes the process.

With the second embodiment described above, as with the first embodiment, since the control unit 11 restricts one or some of the functions of the vehicle 4 through remote control when the control unit 11 receives the first signal, it is possible to urge the debtor to make a payment on the debt.

### Other Embodiments

Further effects and modifications can be easily derived by those skilled in the art. Thus, the broader aspects of the present disclosure are not limited to the specific details and representative embodiments illustrated and described as above. Therefore, various changes can be made without departing from the spirit or scope of the general concept of the disclosure defined by the appended claims and their equivalents.

For example, in the first and second embodiments, the description has been made assuming the credit collection server 1 or the vehicle 4. However, the credit management server 2 or the vehicle information server 3 itself may include the functions of the control unit 11 or the ECU 41. In this case, the credit management server 2 or the vehicle information server 3 may include the functions of the control unit 11 and the vehicle history DB12 of the credit collection server 1. In addition, in the vehicle control apparatus according to the first and second embodiments, the vehicle 4 may execute one or some of the processes of the credit collection server 1 or the vehicle information server 3.

In addition, in the description of the embodiments of the present disclosure, the credit collection server 1, the credit management server 2, and the vehicle information server 3 are separate devices. However, the credit collection server 1, the credit management server 2, and the vehicle information server 3 may be configured as one or two, or four or more devices.

What is claimed is:

1. A vehicle control apparatus comprising a processor configured to execute control such that at least an electronic toll collection system wireless device included in a target vehicle is disabled when the processor receives, from an information processing device, a first signal indicating that a payment of a debt for the target vehicle is not properly made.

2. A vehicle control apparatus comprising a processor configured to restrict one or some of functions included in a target vehicle when the processor receives a first signal indicating that a payment of a debt for the target vehicle is not properly made.

3. The vehicle control apparatus according to claim 2, wherein the restriction of the one or some of the functions includes executing control such that an electronic toll collection system wireless device is disabled.

4. The vehicle control apparatus according to claim 2, wherein the restriction of the one or some of the functions includes executing control such that an air conditioner is disabled.

5. The vehicle control apparatus according to claim 4, wherein the execution of the control such that the air conditioner is disabled includes executing control such that at least one of heating, cooling, dehumidification, and ventilation of the air conditioner is disabled based on at least one of a current month, a current season, a current temperature, and a current humidity.

6. The vehicle control apparatus according to claim 2, wherein the restriction of the one or some of the functions includes executing control such that opening and closing of a plurality of doors included in the target vehicle other than a predetermined door is disabled.

7. The vehicle control apparatus according to claim 2, wherein the restriction of the one or some of the functions includes executing control such that a response level of at least one of a car navigation system, a voice assistant, and an artificial intelligence agent is made lower than a predetermined value.

8. The vehicle control apparatus according to claim 2, wherein the restriction of the one or some of the functions includes at least one of executing control such that setting of a predetermined area as a destination is disabled and executing control such that a guide to the predetermined area is disabled in a function of a car navigation system included in the target vehicle.

9. The vehicle control apparatus according to claim 2, wherein the processor is configured to
determine whether a second signal indicating that the debt has been fulfilled has been received, and
remove the restriction of the one or some of the functions when the processor determines that the second signal has been received.

10. The vehicle control apparatus according to claim 2, wherein the processor is configured to execute remote control by outputting, to the target vehicle, a signal for restricting one or some of the functions included in the target vehicle through remote control, in response to receiving the first signal.
